(19) United States
(12) Patent Application Publication
(10) Pub. No.: US 2016/0203513 A1
(43) Pub. Date: Jul. 14, 2016

(54) REVERSE SEARCH DATABASE SYSTEM

(71) Applicant: Richard A. Ferdinand, Old Tappan, NJ (US)

(72) Inventor: Richard A. Ferdinand, Old Tappan, NJ (US)

(21) Appl. No.: 15/074,494

(22) Filed: Mar. 18, 2016

Related U.S. Application Data
(63) Continuation of application No. 14/870,240, filed on Sep. 30, 2015.
Application No. 14/870,240 is a continuation of application No. 14/036,681, filed on Sep. 25, 2013, now abandoned.
(60) Provisional application No. 61/705,421, filed on Sep. 25, 2012.

(51) Int. Cl. G06Q 30/02; G06F 17/30

(52) U.S. Cl. CPC G06Q 30/0255; G06F 17/30675

(57) ABSTRACT

Disclosed herein are methods useful for reverse-searching, and categorizing consumer markets and preferences according to consumer and/or viewer interaction, in any type of display format, which in turn creates consumer and/or viewer interaction data. The data is then used to process the reverse-search within a database. The methods generally can be utilized for commercial purposes, by a business, such as for advertising or solicitation to the viewer. Also disclosed herein is the incorporation of the Pre-Search Query Label Stack into the reverse-search which improves the quality and reliability of the reverse-search. The methods can provide new and improved commercial success in advertising, education, training, branding, promotional activity, notice, offer and solicitation by the business to the consumer or viewer.

### BACKGROUND

This application relates generally to methods for marketing and advertising to viewers of any medium, but is also applicable across many other disciplines. Specifically, it relates to finding viewers who individually, or on a group basis, have displayed or indicated personal interests and/or preferences and have displayed or indicated a potential for a personal interest-in, or preference for, a variety of products, activities and/or services using a reverse-search method within a viewer database. More particularly this relates to methods that facilitate and improve compilations of consumer preferences and potential preferences to products and/or services based on a variety of factors, and specifically though the Pre-Search Query Label Stacking System. Reverse-search methods and Pre-Search Query Label Stacking Systems are most frequently applied in the recognition, identification, organization and retrieval of commercially valuable information regarding consumers and potential consumers and groups of such.

### DESCRIPTION OF RELATED ART

For a variety of reasons including the prevalence of marketing and advertising practices, or other service or product reasons, the volume, frequency and extent of searches for data regarding consumer engagements with all forms of digital data and specifically searches for data indicating commercially valuable consumer interests and preferences or potential interests and preferences has increased. For example, U.S. businesses are currently trying to find search methods to define and create replacement advertising content and media to fill the $40 billion advertising gap that has been created due to the significant drop in circulation and mass exodus of local newspapers and magazines in the U.S. marketplace. Business need new abilities to predict, estimate, track and measure the impact of their commercially valuable offerings on the consumer or viewer, as well as to further synthesize their respective data for efficient search and retrieval.

One aspect that most if not all these business are facing share is the need to target consumers or viewers for their products or services, for example through a reverse-search. Typically, a business is forced to advertise or market through a paper or digital medium in somewhat of a blanket approach.

Moreover, it is cumbersome when a business attempts to locate and target groups of consumers that have interests or preferences for a particular product or service. There are methods that can track consumers' and viewers' data and transactions on the internet through cookies and clear gifs, but the this is a tedious and complicated process. In person consumer data and transactions are even harder track due to banking regulations when a credit card is used and virtually impossible to track when cash is used. Further, in both instances consumers are not in any searchable database on which to target consumers or viewers and all data reflects a purchase and not an inclination of preferences towards a potentially new product or service.

The targeting of markets of consumers are extremely important, as businesses can fail based improper advertising or marketing which in turn creates low sales figures. The accuracy and precision of businesses' marketing and advertising efforts are of utmost importance to the survival of a company in order to capture the proper market share of potentially interested consumers. Any errors in theses arenas can potentially doom a business.

There is a need for alternative and improved method to locate consumers and viewers that have or can potentially have preferences for certain products or services within a database.

### SUMMARY

Methods to create and continuously improve databases composed of consumers or viewers with interests, preferences or potential inclinations towards certain actions, services or products that are derived from their interaction data, which are used to reverse-search such consumers for such preferences in order to provide such consumers with potential products or services for marketing and advertising purposes.

This method can be utilized once a viewer or consumer interacts with information provided on any display format or as a display specifically mentioned in GAME-BASED ADVERTISING SYSTEM AND METHOD (U.S. 2013-0123025), for example for compiling commercially valuable data.

Contained on the display are choices or interactions the viewer makes, anonymously through an Anonymous Recognition Code (ACR) or non-anonymously, which creates viewer data. Such data could be the price range of the product interacted with by the viewer. The price range would represent a label stack of pointers within the Pre-Search Query Label Stacking System. Other stacks could be descriptions of a product or service, or location of the display format, or clustered pointers of times, locations and indicators for prior same consumer interactions.

For example, if you had a consumer whose data displayed that she interacted with products in the $50-$100 dollar range, had interactions with a display in a Jewish Restaurant and Hospital Neighborhood, and had interests in dolls and car seats, then reverse-search would indicated that high value advertisements would be gifts for Jewish holidays, kosher food, toys and children's clothes. Further, the reverse search could use inferential knowledge that the consumer is Jewish, which automatically triggers a search of the P-SQLS data stacks for pointers that indicate offerings of other potential products and services.

The consumer or viewer data may be analyzed to identify commercially valuable information that could not, in the absence of this invention, be obtained regarding single party influences on purchases, decisions and choices of individual members of a consumer group or of aggregates, up to and including whole members of groups. Searches of pre-structured stacks may enable the new construction of additional stacks that may in turn be searched to predict additional commercially valuable commonalities in the influences or aggregates of group member influences on purchases, decisions and choices of individual members of a consumer group or of aggregates including the whole group. Secondary label stacks are one step removed from primary data solicitation and recording activities. These may be used as compilations that indicate new potential advertisers and other promotional users of the system.

All of the stacks are continuously subjected to informed changes. The system searches for indicators of commercially valuable consumer interests and preferences, scores and compiles said indicators and may direct new messages including advertising, branding, promotional activity, notice, offer or solicitation messages to the interactive fields of view of consumers and consumer groups. The system is designed to continuously update and upgrade the acquired valuable commercial data.

The reverse-search database system reverses the traditional search equations as in this method the product or services searches for the consumer or viewer, as individuals or groups that exhibits commercially desirable characteristics. The interacting person or groups are represented in the label stacks and within the database.

### BRIEF DESCRIPTION OF DRAWINGS

FIG. 1: A depiction of Consumer Analytics Via Pre-Search Query Label Stacking System, showing the main parts including the central system controller 1, surrounded by a compiler 2, connected to a Pre-Search Query Label Stacking System 3, which receives data from a creation pointers 4. The Pre-Search Query Label Stacking System 3 also receives and gives data from a computerized semantic system to pre- structure PSQ label Stacks 6 and P-SQL Commonalities Search Engine 5. The Pre-Search Query Label Stacking System 3 provides output to the data insertion interface 10 which provides data to the interactive electronic display panel 8. The interactive electronic display panel 8 provides data to the data collection interface 9 which provides data to the creation of pointers 4. The P-SQL Commonalities Search Engine 5 receives and provides data from the PSQLS Independent Libraries Search Engine 7. Creation of free-standing lists of startup pointers 4a receives and provides data from creation pointers 4 and computerized semantic system to pre-structure PSQ label stacks 6.

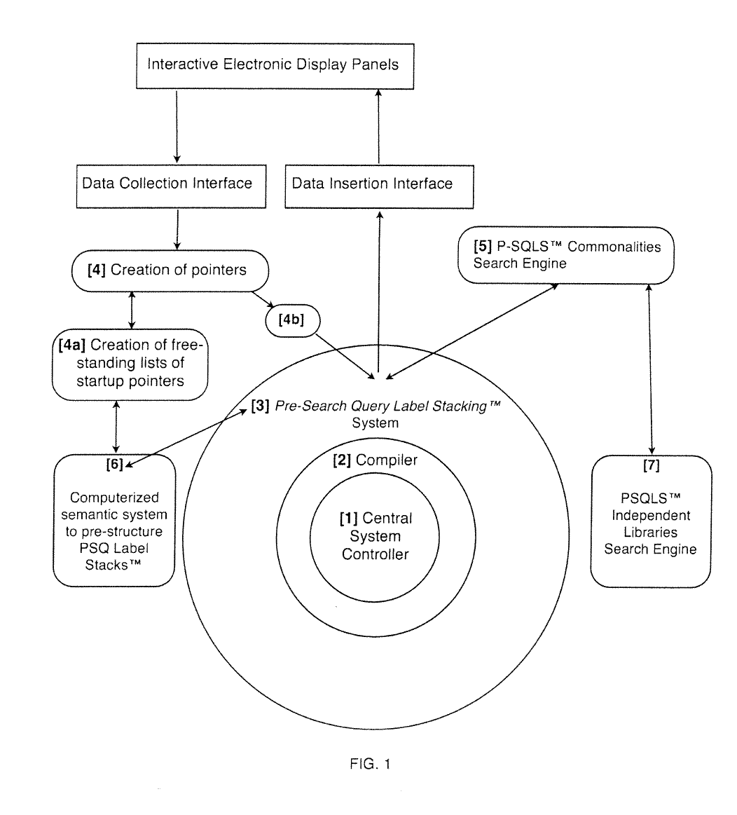

### LIST OF REFERENCE NUMBERS FOR THE MAJOR ELEMENTS IN THE DRAWING

The following is a list of the major elements in the drawings in numerical order.
1. Central system controller.
2. Compiler
3. Pre-Search Query Label Stacking System.
4. Creation of pointers
4a. Creation of free-standing lists of start up pointers.
4b. Transition from pointers into the Pre-Search Query Label Stacking System.
5. P-SQL Commonalities Search Engine.
6. Computerized semantic system to pre-structure PSQ Label Stacks.
7. P-SQLS Independent Libraries Search Engine.
8. Interactive Electronic Display Panels.
9. Data Collection Interface.
10. Data Insertion Interface.

### DETAILED DESCRIPTION

Provided herein are methods for creating and improving viewer and consumer databases, particularly in advertising and marketing by allowing businesses to locate and/or communicate messages to and from viewers and consumers who have or can potentially have a preferences for said businesses' products and/or services through a reverse-search based on viewer data within a database.

The inventors have discovered that a reverse search based on a consumer analytics database systems, in particularly through a Pre-Search Query Label Stacking System herein unexpectedly provided a substantially improved result over current tools for this purpose and over current practices in the marketing and advertising industry.

The invention requires the use of a computerized system which is operated by a central controller 1 to collect and sort consumer or viewer data. In addition a compiler 2 will be incorporated to compile reports related to data collected from either anonymous or non-anonymous electronic interactions between any form of electronic communication system or systems, and individual potential consumers and groups of potential consumers who, via interactions with the displayed content available on the communication system, indicate interest or non-interest in content displayed electronically or optically within display panels wherein said panel content may be in the form of advertising, branding, promotional activity, notice, offer or solicitation.

The computerized system will treat all said panel content as individual questions and/or collective group queries for data collection purposes wherein the interest or non-interest indicated by the party or group by choice, interacting, or not interacting with a specific display panel is in part recorded by the Pre-Search Query Label Stacking System 3. A creation of pointers 4 is created and a pointer is a descriptive term relating to the panel content and is also a variable whose value includes the address of another variable as in a “link” in computer terms. In this context, a choice by a viewer to interact with the interactive electronic panel 8 is evaluated as an indication of interest and a potential signal of consumer preferences.

To utilize the method the computerized system will have the creation of free-standing lists of startup pointers 4a, which are available for assignment before, in semantic terms, the question or query is presented on the interactive electronic panel 8 to the interacting party and where all pointers 4b become elements of Pre-Search Query Label Stacking System 3.

This allows all of stacks within the Search Query Label Stacking System 3 to be searched in relation to elements of all other label stacks to identify and quantify commonalities in relation to a single party question and/or group queries by the P-SQLS Commonalities Search Engine 5 as was posed to the interacting party or groups on the system.

Each interaction may be associated with more than one pointer. Pointers can be created as individual descriptive terms or phrases, in any language, that indicate commercially valuable information about attributes of any content that is assessed by individual or group interactions. Pointers may be created in relation to intrinsic, commercially valuable, information about specific panel content and/or extrinsic information. For example, a pointer indicating that the consumer or group in question frequent specific ethnically orientated restaurants or neighborhoods.

The computerized system will also contain a semantic system to pre-structure PSQ label stacks 6, which include plain language words or phrases that have scored commercial value as indicators of interest, non-interest and/or as indicators of preferences of interacting parties or groups. Scoring is provided and mapped onto Pointers 4 and PSQ label stacks 6 by a database analyst and/or by automated computerized systems.

The PSQ label stacks 6 have automated scoring of labels with respect to likely interests and preferences of interacting viewers or consumers. Further, automated recommendations, targeting and implementation action of follow up advertisements, enticements or promotions are based upon scored interests or preferences for the purpose of providing consumers with more information with respect to the displayed content. Advertisements are dispersed according to formulas that are informed by predictive analysis of selected PSQ Label Stacks and by prior inferential knowledge of how to selectively address panels to reach the interactive fields of view of certain groups of socially connected anonymous persons that represent informed potential additional buying power and likely shared interests and preferences in relation to the content of any advertisement panel.

The computerized system where PSQ label stacks 6 may be searchable as independent libraries of data containing potential indications of commercially valuable commonalities among otherwise disparate and heterogeneous pointers.

The preferred embodiment of the present invention is described herein in the context of a marketing, education, training and advertising, but is not limited thereto, except as may be set forth.

1. A method of using viewer data in order to reverse-search consumer analytics in a database comprising the steps of:
(a) utilizing commercial value of words and expressions in any language that relates to information, wherein in said information includes advertising, education, training, branding, promotional activity, notice, offer or solicitation;
(b) providing said information in any display format to a viewer;
(c) displaying said information in order for the viewer to interact with the information which creates a viewer's data;
(d) using said viewer's data and conducting a reverse-search, within a database, for any reason, including for viewer's preferences, tastes, marketing and advertising purposes; and
(e) presenting said viewer, in any display format, with potentially inclined products and services based on the results of said reverse-search.

2. A method according to claim 1, further comprising the additional step of:
(a) creating a Pre-Search Query Label; and
(b) including said Pre-Search Query Label Stacks to a semantic library within the information and the reverse-search system.

3. A method according to claim 2, further comprising the additional step of scoring the contents of the Pre-Search Query Label Stacks by database analyst in relation to probable and possible commercial value.

4. A method according to claims 1, further comprising the additional steps of:
(a) scoring the semantic contents of the Pre-Search Query Label Stacks in relation to probable and possible commercial value; and
(b) using a computerized flagging, detecting and recording system that has access to a database of viewers, including but not limited to all active and issued ARC, anonymous recognition codes, that are equipped to scan all physical and cyber panel locations on said system for relevant data, wherein said relevant data includes extrinsic contextual data.

5. A method according to claim 4, further comprising the additional steps of:
(a) correlating the contents of all Pre-Search Query Label Stacks;
(b) identifying potentially hidden relationships;
(c) exploiting said relationships for commercial purposes; and
(d) updating said semantic library in accordance with the scoring of any commercial values in the newly discovered hidden relationships.

6. A method according to claim 4, further comprising the additional steps of:
(a) utilizing automatically the scores of the semantic contents of the Pre-Search Query Label Stacks;
(b) creating profiles of likely new advertisers;
(c) populating said profiles with automatically generated predictive models of performance;
(d) using said predictive models in order to attract advertisers as new customers to said system; and
(e) creating automatic pricing, dispersion, and circulation models for the new customers according to needs.

7. A method according to claim 4, further comprising the additional steps of:
(a) correlating automatically the contents of the Pre-Search Query Label Stacks;
(b) identifying relationships within the contents;
(c) creating a entertaining computerized educational and commercial training system;
(d) offering said system to viewers in a panelized electronic presentation format wherein a schedule of interests and preferences of individuals and groups are pre-recorded in Pre-Search Query Label Stacks;
(e) mining said Pre-Search Query Label Stacks for data; and
(f) incorporating said system with educational and training course contents.
